(19) United States
(12) Patent Application Publication
(10) Pub. No.: US 2009/0289932 A1
(43) Pub. Date: Nov. 26, 2009

(54) POWER SUPPLY CIRCUIT AND LIQUID CRYSTAL DISPLAY APPARATUS

(76) Inventor: Shuji Nishi, Nara-shi Nara (JP)

Correspondence Address: HARNESS, DICKEY & PIERCE, P.L.C., P.O. BOX 8910, RESTON, VA, 20195, US

(21) Appl. No.: 12/309,948

(22) PCT Filed: Jun. 27, 2007
(86) PCT No.: PCT/JP2007/062908

§ 371 Date: Feb. 4, 2009

(30) Foreign Application Priority Data
Sep. 8, 2006 (JP) 2006-244781

(51) Int. Cl. G09G 3/36; G09G 5/00

(52) U.S. Cl. 345/212

(57) ABSTRACT

In one embodiment of the present invention, a reset signal changes into a High level in sync with rising and falling edges of a common electric potential. This causes a comparator to be reset in sync with the rising and falling edges of the common electric potential, so that a comparator output signal is maintained in a ground level. Therefore, even if a voltage held by a capacitor is suddenly changed by the inversion of the common electric potential, a wrong comparator output signal cannot be outputted. In a charge pump type power supply circuit having, for the purpose of regulating an output voltage, the comparator that fulfills an offset cancel function by using the capacitor, it is possible to obtain a stable output with little fluctuation without being affected by a change in the common electric potential of a common electrode of pixels in a liquid crystal display apparatus.

### TECHNICAL FIELD

The present invention relates to a power supply circuit having a function of regulating an output voltage, and to a liquid crystal display apparatus including the same.

### BACKGROUND ART

In a device such as a liquid crystal display apparatus, there is provided a power supply circuit for generating a plurality of power supply voltages based on a single power supply voltage so that different power supply voltages to be supplied to each section of the device are prepared. Exemplified as such a power supply circuit is a power supply circuit disclosed in Patent Document 1, for example.

The power supply circuit has a charge pump circuit, a voltage divider circuit, and a regulation circuit. The charge pump circuit carries out a charge pump operation in sync with a clock pulse so as to output an output voltage. The voltage divider circuit divides a voltage difference between the output voltage and an internal power supply voltage. The regulation circuit controls supply and supply stop of the clock pulse to the charge pump circuit, based on a comparison result of a comparator between a reference voltage and a voltage outputted from the voltage divider circuit.

Power supply circuits having such a regulation function have been commercialized. In some of the power supply circuits, the comparator is provided as a chopper type comparator. For example, Patent Document 2 discloses a chopper type comparator, which has an input changing-over switch, a capacitor, an inverter, and an input-output short circuiting switch.

In the chopper type comparator, either a comparison voltage or the reference voltage is selected by the input changing-over switch so as to be supplied to the capacitor. Then, a voltage charged by the capacitor is inverted by the inverter. When the reference voltage is supplied to the capacitor while an input terminal and an output terminal of the inverter are short-circuited in response to the input-output short circuiting switch being ON, the capacitor is charged in accordance with a voltage difference between the reference voltage and a threshold voltage of the inverter. When the comparison voltage is supplied to the capacitor while the input-output short circuiting switch is OFF, the comparator compares the comparison voltage with the reference voltage so as to output a signal having a High level or a Low level in accordance with a compared result. In this chopper type comparator, a variation (offset) in output voltage due to the threshold voltage of the inverter is canceled because the capacitor is charged in accordance with the voltage difference.

### [Patent Document 1]

Japanese Patent No. 3687597 (Tokkyo 3687597) (publication date: Aug. 24, 2005)

### [Patent Document 2]

Japanese Unexamined Patent Publication No. 9-197916 (Tokukaihei 9-197916) (publication date: Jul. 31, 1997)

### [Patent Document 3]

Japanese Unexamined Patent Publication No. 2004-184840 (Tokukai 2004-184840) (publication date: Jul. 2, 2004)

### DISCLOSURE OF INVENTION

In the power supply circuit described above, the regulation circuit operates only during a certain period, and its output is sampled and held. This causes, during a 1H period (horizontal scanning period), the charge pump circuit to become in a state in which it continues to operate or in a state in which it continues to stop operation. This results in an increase in difference of the output voltage between the two states. As a result, the output voltage greatly fluctuates. Consequently, there arises a problem that an image displayed in a liquid crystal display apparatus is lowered in quality.

Moreover, the following problem is likely to occur in a case where a power supply circuit having a chopper type comparator is used as a power supply circuit for driving an active matrix liquid crystal display apparatus.

In some active matrix liquid crystal display apparatus, an electric potential of a common electrode (counter electrode which faces pixel electrodes), that is provided in common in pixels, is inverted, for example, for every scanning period (1H period), since a liquid crystal should be subjected to AC driving (Patent Document 3). In a case where a power supply circuit having the chopper type comparator is used in such an active matrix liquid crystal display apparatus, a voltage (the difference voltage) charged by the capacitor fluctuates when the common electric potential is inverted while the chopper type comparator is carrying out a comparison. As a result, the chopper type comparator outputs an incorrect comparison result.

This phenomenon occurs as follows. Namely, a parasitic capacitance exists between the common electrode and the capacitor of the chopper type comparator. A change in the common electric potential causes a change in electric charge stored in the capacitor via the parasitic capacitance. Such a phenomenon significantly occurs especially in a liquid crystal display apparatus in which a power supply circuit is provided on a transparent substrate such as glass, together with pixel electrodes and driving circuits.

The present invention has been accomplished in view of the problems above, and an object of the present invention is to provide a charge pump type power supply circuit which can stably output with little fluctuation and without being affected by a change in the common electric potential.

A first power supply circuit in accordance with the present invention is a power supply circuit including: a charge pump circuit for carrying out a charge pump operation so as to supply a power supply voltage to a driving circuit of a liquid crystal display apparatus in which an electric potential of a common electrode shared by a plurality of pixels is inverted so as to have two values in a predetermined cycle; a voltage divider circuit for dividing a difference voltage between an input power supply voltage and a voltage outputted from the charge pump circuit; a regulation circuit including a comparator with a capacitor to be charged by a reference voltage so that the reference voltage is compared with a voltage outputted from the voltage divider circuit, the regulation circuit stabilizing a power output by controlling the charge pump circuit based on a compared result; and a control section for resetting the comparator in the predetermined cycle, and for controlling the comparator to carry out a comparison after the electric potential of the common electrode is inverted.

In this arrangement, the comparator is reset by the control section in the predetermined cycle (every 1H period, for example), that is, in sync with each inversion of the electric potential of the common electrode (common electric potential). Thus, the comparator carries out the comparison after the common electric potential is inverted. The reset of the comparator causes an output signal of the comparator to be maintained in a ground level. Therefore, even if a voltage held by the capacitor is suddenly changed in response to the inversion of the common electric potential, a wrong comparator output signal cannot be outputted.

Further, the output voltage of the voltage divider circuit repeatedly varies since a regulation operation is carried out throughout a period in the predetermined cycle. This causes the charge pump circuit to repeatedly carry out on-off operation throughout the period, so that the output power supply voltage of the charge pump circuit is constrained to vary within a small range.

A second power supply circuit in accordance with the present invention is a power supply circuit including: a charge pump circuit for carrying out a charge pump operation so as to supply a power supply voltage to a driving circuit of a liquid crystal display apparatus in which an electric potential of a common electrode shared by a plurality of pixels is inverted so as to have two values in a predetermined cycle; a voltage divider circuit for dividing a difference voltage between an input power supply voltage and a voltage outputted from the charge pump circuit; and a regulation circuit including a comparator with a capacitor to be charged by a reference voltage so that the reference voltage is compared with a voltage outputted from the voltage divider circuit, the regulation circuit stabilizing a power output by controlling the charge pump circuit based on a compared result, the capacitor being shielded with an electrode layer provided between the capacitor and the common electrode.

In this arrangement, in which the capacitor is shielded with the electrode layer, a voltage held by the capacitor is hardly affected by a variation in the electric potential of the common electrode. Therefore, it is possible to avoid a wrong output signal from being outputted from the comparator as a result of being affected by the inversion of the common electric potential.

Further, in this arrangement, it is not necessary to reset the comparator, unlike the aforementioned power supply circuit. This allows the comparator to efficiently carry out a regulation operation. Therefore, the output power supply voltage is constrained to vary within a small range.

In this way, the first power supply circuit controls the comparator by resetting the comparator in the predetermined cycle by using the control section so as to make the comparator carry out the comparison after the electric potential of the common electrode is inverted. Further, the second power supply circuit has the capacitor that is shielded with the electrode layer provided between the capacitor and the common electrode.

This makes it possible to prevent, in the first and second power supply circuits, the comparator from erroneously operating as a result of being affected by the inversion of the common electric potential. Further, the output power supply voltage of the charge pump circuit is constrained to vary within a small range. This allows an improvement in display quality of an image displayed by the liquid crystal display apparatus, as well as obtaining a stable output power supply voltage. Moreover, since it is not necessary to constantly operate the charge pump circuit, it is possible to reduce a power consumption of the power supply circuit.

It is preferable to arrange the first and second power supply circuits so that the reference voltage includes different first and second reference voltages; and said power supply circuit, further including a switching circuit for switching between the first and second reference voltages in response to an output of the comparator.

With this arrangement, the output voltage of the voltage divider circuit varies between the first reference voltage and the second reference voltage. In other words, the output voltage of the voltage divider circuit stays within a range from the first reference voltage to the second reference voltage. This makes it possible to control the output power supply voltage without being affected by an accuracy of the comparator. Consequently, it becomes possible to obtain a stable output power supply voltage.

In the second power supply circuit, even if the voltage held by the capacitor is changed by the inversion of the common electric potential although the capacitor is shielded with the electrode layer, a regulation operation is carried out so that the voltage stays within the range from the first reference voltage to the second reference voltage. This is because the second power supply circuit uses the first and second reference voltages. Therefore, when the output power supply voltage reaches a reference electric potential that has been affected by the inversion of the common electric potential, a reference voltage is switched to the first or second reference voltage so that the output power supply voltage is corrected. This only causes a slight increase in amplitude of the output power supply voltage. This makes it possible to more surely prevent the comparator from erroneously operating.

A liquid crystal display apparatus of the present invention is a liquid crystal display apparatus including a driving circuit for driving a plurality of pixels, and a power supply circuit, provided, together with the driving circuit, on a translucent substrate on which the plurality of pixels are provided, for outputting a power supply voltage to the driving circuit, the power supply circuit being any one of the above-mentioned power supply circuits, in order to attain the object.

With this arrangement, it is possible to stably supply, to the driving circuit, an output power supply voltage that varies within a small range. Therefore, as described above, it is possible to constrain the output power supply voltage to vary within a small range, as well as preventing the comparator from erroneously operating in the power supply circuit. This allows an improvement in display quality of an image displayed by the liquid crystal display apparatus.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a block diagram showing an arrangement of a liquid crystal display apparatus that shows an embodiment of the present invention.

FIG. 2 is a circuit diagram showing an arrangement of a pixel in the liquid crystal display apparatus.

FIG. 3 is a circuit diagram showing an arrangement of a first power supply circuit served as a power supply circuit provided in the liquid crystal display apparatus.

FIG. 4 is a circuit diagram showing an arrangement of a comparator in the first power supply circuit.

FIG. 5 is a timing chart showing an operation of the first power supply circuit.

FIG. 6 is a circuit diagram of the comparator. In (a) through (c), an OFF-state operation of the comparator is indicated by dashed lines.

FIG. 7 is a circuit diagram showing an arrangement of a second power supply circuit served as a power supply circuit provided in the liquid crystal display apparatus.

FIG. 8 is a timing chart showing an operation of the second power supply circuit.

FIG. 9 is a circuit diagram showing an arrangement of a third power supply circuit served as a power supply circuit provided in the liquid crystal display apparatus.

FIG. 10 is a circuit diagram showing an arrangement of a comparator of the third power supply circuit.

FIG. 11 is a timing chart showing an operation of the third power supply circuit.

FIG. 12 is a view showing an arrangement of a capacitor in the comparator shown in FIG. 10. (a) shows a side structure of the capacitor. (b) shows a cross-sectional structure of the capacitor.

FIG. 13 is a circuit diagram showing an arrangement of a comparator that can be used in each of the power supply circuit.

### BEST MODE FOR CARRYING OUT THE INVENTION

One embodiment of the present invention is described below with reference to FIGS. 1 through 12.

[Arrangement of Liquid Crystal Display Apparatus]

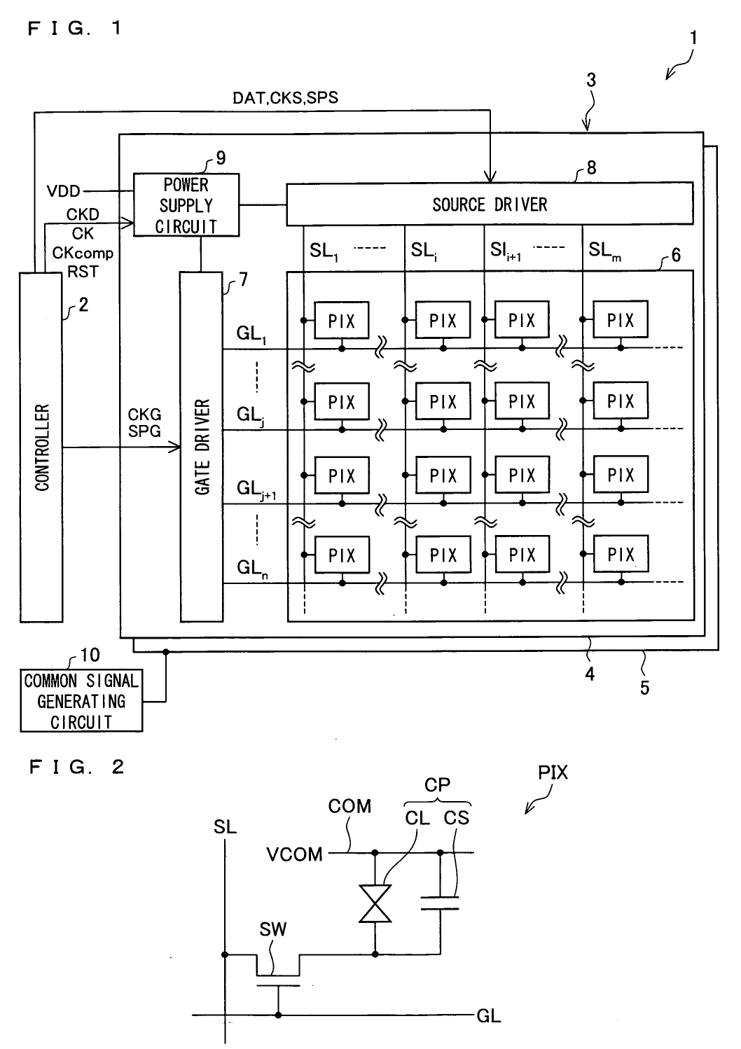

FIG. 1 is a block diagram showing an arrangement of a liquid crystal display apparatus 1. FIG. 2 is a circuit diagram showing an arrangement of a pixel PIX in the liquid crystal display apparatus 1.

As shown in FIG. 1, the liquid crystal display apparatus 1 includes a controller 2 and a liquid crystal panel 3.

The controller 2 (control section) supplies various signals to a gate driver 7, a source driver 8, and a power supply circuit 9, each of which is described later. The controller 2 supplies signals such as a clock signal CKG and a start pulse SPG to the gate driver 7. Further, the controller 2 supplies signals such as a video signal DAT, a clock signal CKS, and a start pulse SPS to the source driver 8. Furthermore, the controller 2 supplies signals such as a clock signal CK, a reset signal RST, a control signal CKcomp, and a clock signal CKD to the power supply circuit 9.

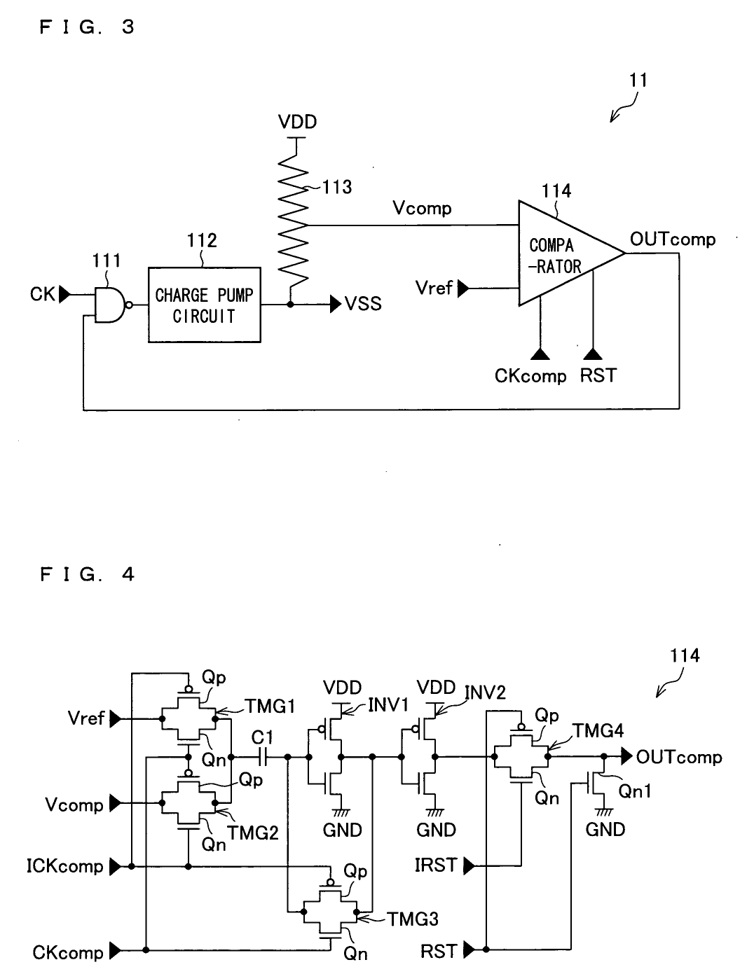

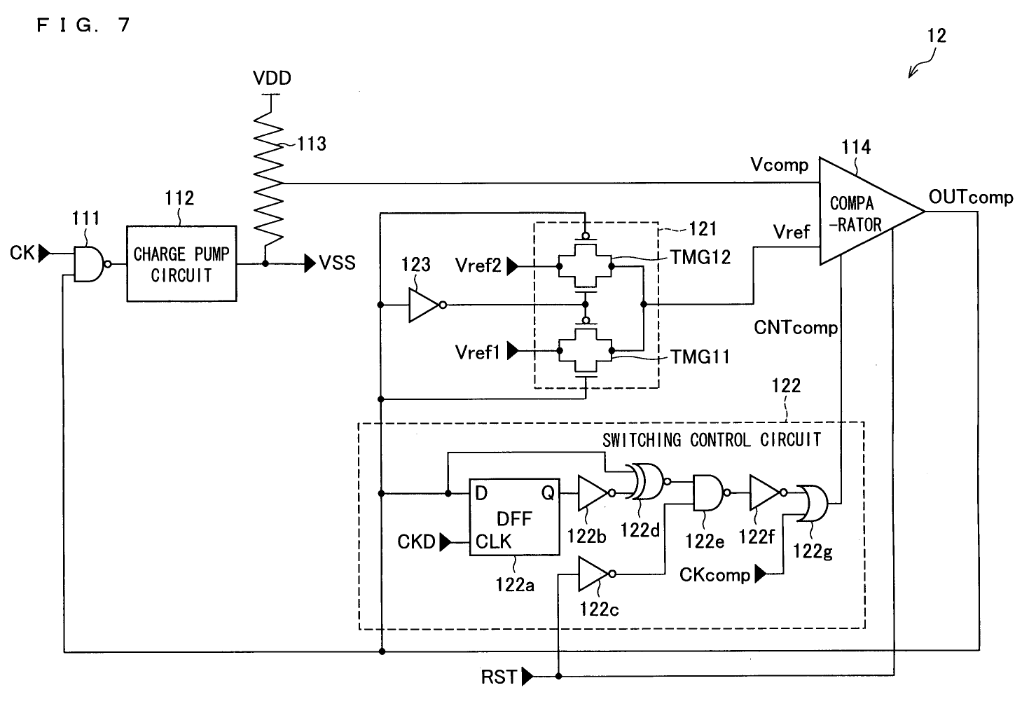

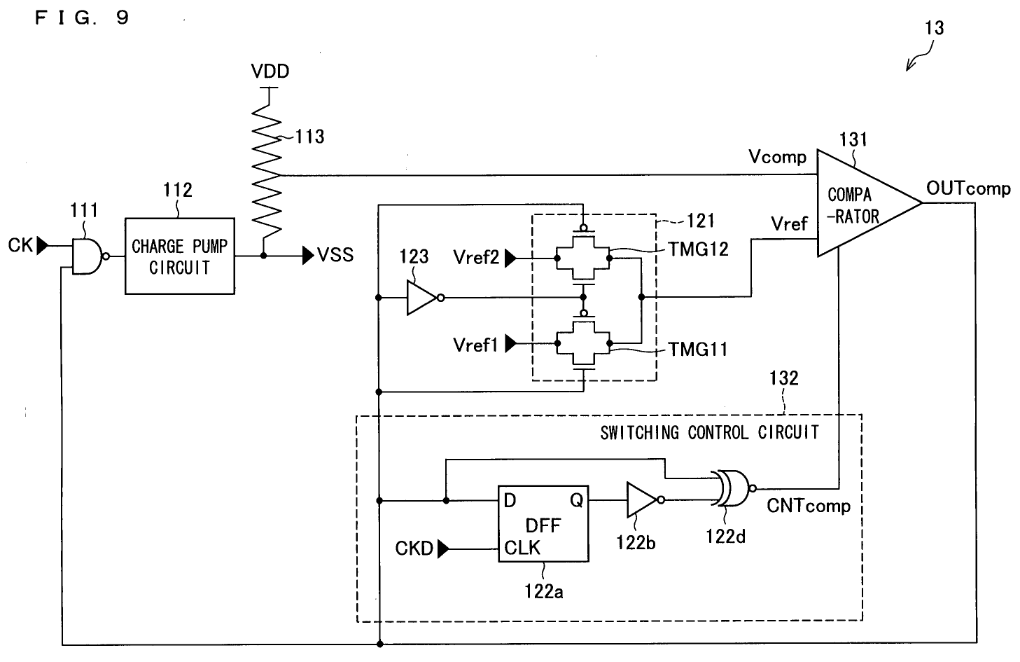

The clock signal CK is a pulse signal, having a certain cycle, for controlling a drive of a charge pump circuit 112 (see FIG. 3) described later. The reset signal RST is a pulse signal, having a cycle of 1H period (horizontal scanning period), for resetting a comparator 114 (see FIG. 3) described later. The control signal CKcomp is a signal, for controlling the comparator 114, in which a pulse exists within a period during which a pulse of the reset signal RST exists. The clock signal CKD is a clock signal to be supplied to switching control circuits 122 and 132 (see FIGS. 7 and 9, respectively) described later.

The liquid crystal panel 3 includes substrates 4 and 5 and a liquid crystal (not shown) filled into the space between the substrates 4 and 5. The substrates 4 and 5 are made from an insulating and translucent material such as glass.

Provided on the substrate 4 are a pixel array 6, the gate driver 7, the source driver 8, the power supply circuit 9, and a common signal generating circuit 10.

The pixel array 6 includes a number of gate lines GL (GL1, . . . , GLj, GLj+1, . . . , Gln) serving as scanning lines, a number of source lines SL (SL1, . . . , SL1, SLi+1, . . . , SLm) serving as data lines, and a plurality of pixels (indicated by PIX in FIG. 1). The gate lines GL and the source lines SL intersect with each other. The pixels PIX are provided near the intersections of the gate lines GL and the source lines SL, respectively. This causes all of the pixels PIX to be arrayed in a matrix manner in the pixel array 6.

As shown in FIG. 2, each of the pixels PIX includes a pixel transistor SW (thin film transistor), serving as a switching element, and a pixel capacitor section CP (an auxiliary capacitor section CS is added if necessary) including a liquid crystal capacitor section CL. In such a pixel PIX, one electrode (pixel electrode) of the pixel capacitor section CP is connected to the source line SL, via a drain and source of the pixel transistor SW. A gate of the pixel transistor SW is connected to the gate line GL. The other electrode of the pixel capacitor section CP is connected to a common electrode COM that is provided in common in all of the pixels PIX.

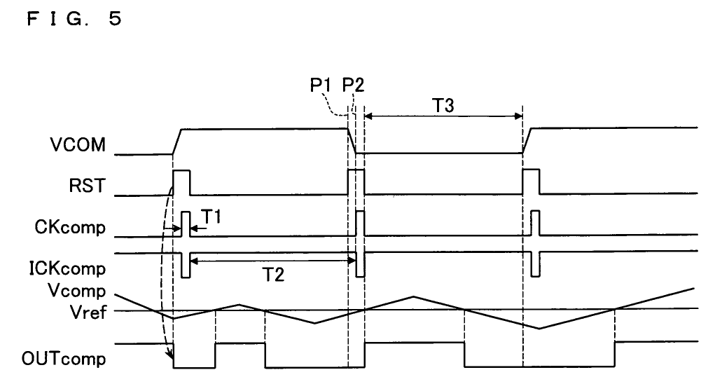

The common electrode COM is provided on the substrate 5. Supplied to the common electrode COM is a common signal VCOM that alternately changes its value at the start of each 1H period (see FIG. 5). Meanwhile, a voltage which varies depending on the video signal DAT is applied to the pixel electrode via the source line SL. A transmittance and reflectance of the liquid crystal is modulated in response to a voltage applied to the liquid crystal capacitor section CL via the pixel electrode. This causes an image to be displayed on the pixel array 6 in accordance with the video signal DAT.

The gate driver 7 (scanning line driving circuit) generates scanning signals (gate pulse) by sequentially shifting the start pulse SPG in sync with the clock signal CKG. The scanning signals are supplied to the gate lines GL which are connected to the pixels PIX provided in rows, respectively. The scanning signals control switching of the switching elements SW so that pixel data supplied to the source lines SL are written into and held by the pixels PIX, respectively.

The source driver 8 (data line driving circuit) samples video signals DAT (video data) corresponding to one line based on pulses generated by sequentially shifting the start pulse SPS in sync with the clock signal CKS. The sampled video signals DAT corresponding to one line are supplied, as the pixel data, to the data signal lines SL which are connected to the pixels PIX arranged in columns, respectively.

The power supply circuit 9 is a circuit for generating power supply voltages to be applied to the gate driver 7 and the source driver 8. The gate driver 7 and the source driver 8 include shift registers for shifting the start pulse SPG and the start pulse SPS, respectively. Each of the gate driver 7 and the source driver 8 each include such a shift register is constituted by a CMOS logic circuit. Each of the gate driver 7 and the source driver 8 requires power supply voltages on the sides of higher and lower electric potentials. The power supply circuit 9 supplies such a plurality of different power supply voltages based on a single input power supply voltage VDD.

In order to realize demands for downsizing, improvement in reliability, and cost reduction of a display apparatus, there has become common a technique in which a gate driver 7 and a source driver 8 are provided, on a single substrate 4 where a pixel array 6 is provided, so as to be integral with each other. In such a display apparatus in which driving circuits are provided so as to be integral with each other, especially in the liquid crystal display apparatus 1 (a transmissive liquid crystal display apparatus that is widely used at present), the substrate 4 has to be made from a transparent material. Therefore, polycrystalline silicon thin film transistors which can be provided on a quartz substrate and a glass substrate are often used as active elements of the pixel array 6, the gate driver 7 and the source driver 8.

The common signal generating circuit 10 includes an inverter circuit in order to generate the common signal VCOM. In the common signal generating circuit 10, the inverter circuit alternately switches between externally-inputted two voltages (inverts the externally-inputted voltage) for every 1H period, and then outputs one of the voltages.

[Arrangement of First Power Supply Circuit]

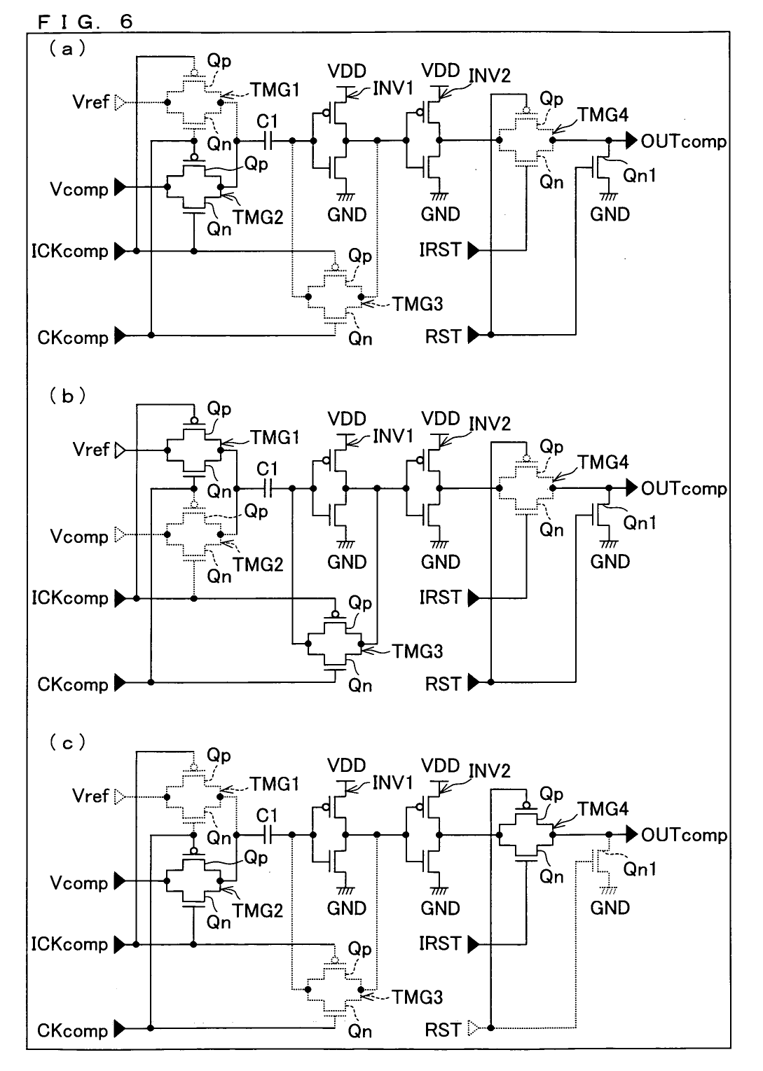

A power supply circuit 11 (first power supply circuit) is described below as a concrete example of the power supply circuit 9, with reference to FIGS. 3 through 6. FIG. 3 is a circuit diagram showing an arrangement of the power supply circuit 11. FIG. 4 is a circuit diagram showing an arrangement of a comparator 114 provided in the power supply circuit 11. FIG. 5 is a timing chart showing an operation of the power supply circuit 11. (a) through (c) of FIG. 6 are circuit diagrams each showing the comparator 114, in which an OFF-state operation is indicated by dashed lines.

The power supply circuit 11 is a circuit for outputting a negative output power supply voltage VSS (more than or equal to −VDD) based on an input power supply voltage VDD.

As shown in FIG. 3, the power supply circuit 11 includes a NAND gate 111, a charge pump circuit 112, a voltage divider circuit 113, and a comparator 114.

The NAND gate 111 carries out a NAND operation with respect to the clock signal CK supplied from the controller 2 and an output signal OUTcomp of the comparator 114.

The charge pump circuit 112 is a circuit for carrying out a charge pump operation based on the output signal of the NAND gate 111. The charge pump circuit 112 has a circuit configuration similar to that in the power supply circuit disclosed in Patent Document 1. An output voltage of the charge pump circuit 112 is supplied, as an output power supply voltage VSS of the power supply circuit 11, outside of the power supply circuit 11.

The voltage divider circuit 113 is a circuit for dividing a voltage difference between the input power supply voltage VDD and the output voltage of the charge pump circuit 112 (output power supply voltage VSS) in accordance with a resistance ratio (a certain ratio of 1/2, for example), and then outputting the voltage thus divided.

The comparator 114 compares a reference voltage Vref to a comparison voltage Vcomp (output voltage of the voltage divider circuit 113). The comparator 114 outputs a comparison output signal OUTcomp having a High level when the comparison voltage Vcomp is greater than the reference voltage Vref, whereas outputs a comparison output signal OUTcomp having a Low level when the comparison voltage Vcomp is smaller than the reference voltage Vref. An arrangement of the comparator 114 is described later in detail.

It should be noted that the reference voltage Vref can be generated by the controller 2, or can be generated inside or outside the power supply circuit 11 based on the input power supply voltage VDD, for example.

In the power supply circuit 11, the NAND gate 111 and the comparator 114 constitute a regulation circuit for controlling supply and supply stop of the clock signal CK to the charge pump circuit 112.

An arrangement of the comparator 114 is described below with reference to FIG. 4.

As shown in FIG. 4, the comparator 114, which is a chopper type comparator, includes transmission gates TMG1 through TMG4 (analog switch), a capacitor C1, inverters INV1 and INV2, and an n-channel transistor Qn1.

Each of the transmission gates TMG1 through TMG4 is a circuit in which a p-channel transistor Qp and an n-channel transistor Qn are connected to each other in parallel. Each of the transmission gates TMG1 through TMG4 turns ON when (i) the n-channel transistor Qn has a gate electric potential of High level and (ii) the p-channel transistor Qp has a gate electric potential of Low level. Meanwhile, each of the transmission gates TMG1 through TMG4 turns OFF when (i) the n-channel transistor Qn has a gate electric potential of Low level and (ii) the p-channel transistor Qp has a gate electric potential of High level.

The reference voltage Vref is supplied to the transmission gate TMG1, and the comparison voltage Vcomp is supplied to the transmission gate TMG2. Further, a clock signal CKcomp is supplied to a gate of the n-channel transistor Qn of the transmission gate TMG1 and a gate of the p-channel transistor Qp of the transmission gate TMG2. Meanwhile, an inverted clock signal ICKcomp, obtained by inverting the clock signal CKcomp, is supplied to a gate of the p-channel transistor Qp of the transmission gate TMG1 and a gate of the n-channel transistor Qn of the transmission gate TMG2.

With the circuit configuration, while the clock signal CKcomp is in a High level and the inverted clock signal ICKcomp is in a Low level, the transmission gate TMG1 turns ON, whereas the transmission gate TMG2 turns OFF. Conversely, while the clock signal CKcomp is in a Low level and the inverted clock signal ICKcomp is in a High level, the transmission gate TMG1 turns OFF, whereas the transmission gate TMG2 turns ON.

The transmission gates TMG1 and TMG2 have output terminals that are connected to input terminals of the inverter INV1 and the transmission gate TMG3, respectively, via the capacitor C1. The inverters INV1 and INV2 are CMOS circuits. The inverter INV2 is connected in series with the inverter INV1.

In the transmission gate TMG3, the clock signal CKcomp is supplied to a gate of the n-channel transistor Qn, whereas the inverted clock signal ICKcomp is supplied to that of the p-channel transistor Qp. Therefore, the transmission gate TMG3 operates in the same way as the transmission gate TMG1. The transmission gate TMG3 has an output terminal connected to an output terminal of the inverter INV1 and an input terminal of the inverter INV2.

The transmission gate TMG4 has an input terminal connected to the output terminal of the inverter INV2. Further, an output signal of the transmission gate TMG4 is outputted from the comparator 114 as a comparator output signal OUTcomp. In the transmission gate TMG4, a reset signal RST is supplied to a gate of the p-channel transistor Qp, whereas an inverted reset signal IRST, obtained by inverting the reset signal RST, is supplied to a gate of the n-channel transistor Qn.

With the circuit configuration, the transmission gate TMG4 turns OFF while the reset signal RST is in a High level and the inverted reset signal IRST is in a Low level. Conversely, the transmission gate TMG4 turns ON while the reset signal RST is in a Low level and the inverted reset signal IRST is in a High level.

The n-channel transistor Qn1 is connected between a ground line GND and an output terminal of the transmission gate TMG4. Further, the reset signal RST is supplied to a gate of the n-channel transistor Qn1. This causes the n-channel transistor Qn1 to turn ON while the reset signal RST is in a High level, so as to electrically connect the output terminal of the transmission gate TMG4 (output terminal of the comparator 114) to the ground line GND. Conversely, the n-channel transistor Qn1 turns OFF while the reset signal RST is in a Low level, thereby not electrically connecting the output terminal of the transmission gate TMG4 to the ground line GND.

The reset signal RST changes into a High level from a Low level when the common signal VCOM (electric potential of the common electrode COM, that is, a common electric potential) starts to change, and then changes into a Low level after the High level is maintained for a certain period. That is to say, the reset signal RST rises in sync with a change in the common signal VCOM. Further, the clock signal CKcomp has a clock pulse in a High level during a period when the reset signal RST is in a High level.

In the comparator 114, the first and second inverters INV1 and INV2 are provided. However, it is also possible to provide only the first inverter INV1. Nonetheless, if there is a small difference between the reference voltage Vref and the comparison voltage Vcomp, then a signal to be outputted from the inverter INV1 will gradually change to become, after certain time elapses, an inverted output having a normal level. In view of this, the second inverter INV2 is provided so as to amplify the output signal of the first inverter INV1. This causes the output of the comparator to be rapidly inverted to a normal level. Consequently, the comparator circuit 114 attains a higher accuracy, thereby reducing an amplitude of the output power supply voltage VSS.

An operation of the power supply circuit 11 arranged as above is described below with reference to a timing chart shown in FIG. 5 and to FIG. 6, which shows operation states of the comparator 114.

As shown in FIG. 5, the reset signal RST rises in sync with rising and falling edges of the common signal VCOM. At this point, as shown in (a) of FIG. 6, the n-channel transistor Qn1 turns ON so that the output terminal of the comparator 114 is electrically connected to the ground line GND. This causes the comparator output signal OUTcomp to change into a Low level from a High level. As a result, the clock signal CKcomp stops being supplied to the charge pump circuit 112 via the NAND gate 111, so that the charge pump circuit 112 stops operating. Note, at this point, each of the transmission gates TMG1, TMG3, and TMG4 is in an OFF state.

Then, as shown in FIG. 5, the clock signal CKcomp becomes a High level slightly after the rising edge of the reset signal RST. In a period T1 during which the clock signal CKcomp is maintained in a High level, as shown in (b) of FIG. 6, the transmission gates TMG1 and TMG3 are in an ON state, whereas the transmission gate TMG2 is in an OFF state (indicated by dashed lines), so that the reference voltage Vref charges the capacitor C1. Note that the period T1 is a preparation period for a comparison operation of the comparator 114. In this way, the preparation period is set in the period T1 within a reset period.

Further, at this point, the input terminal and the output terminal of the inverter INV1 are connected to each other via the transmission gate TMG3. This causes a pass-through current to flow through the inverter INV1 from a p-channel transistor via an n-channel transistor. As a result, an inverted threshold voltage Vth occurs at the input terminal and the output terminal of the inverter INV1. Consequently, the capacitor C1 is charged by a voltage Vc (Vref−Vth) that is a difference between the reference voltage Vref and the inverted threshold voltage Vth of the inverter INV1. This makes it possible to charge the capacitor C1 without being affected by a variation in threshold voltage of MOS transistors that constitute the inverter INV1.

In case of an active matrix liquid crystal display apparatus using a thin film transistor (TFT), materials and processes for production are limited if a power supply circuit and the like are monolithically formed on a glass substrate. This causes a variation in characteristic of the TFT to become larger than that in characteristic of a transistor produced by an IC process. Used as a method for reducing the variation of the TFTs that constitute a comparator is such a technique called “correlated double sampling” that is generally used in designing of a CCD of a digital camera. The correlated double sampling is one of the techniques for sampling a signal, and is a method for sampling a difference between a reference level and a signal level which are contained in a signal.

As mentioned above, the comparator 114 uses the voltage Vc that is the difference between the reference voltage Vref and the inverted threshold voltage Vth of the inverter INV1. This causes the comparator 114 to compare the comparison voltage Vcomp, which is later supplied, with the reference voltage Vref based only on whether or not the later supplied comparison voltage Vcomp is greater or smaller than the voltage Vc, independently of a variation in threshold voltage of the p-channel transistor and n-channel transistor of the inverter INV1. This allows the comparison not to depend on the variation in characteristic of both of the transistors of the inverter INV1. In this way, the comparator 114 attains an offset function.

Further, as shown in FIG. 5, a period T2 during which the comparison is carried out is a period during which an inverted clock signal ICKcomp is maintained in a High level after the clock signal CKcomp falls in sync with a falling edge of the reset signal RST. During the period T2, each of the transmission gates TMG1 and TMG3 and the n-channel transistor Qn1 is in an OFF state as indicated by dashed lines in (c) of FIG. 6, whereas each of the transmission gates TMG2 and TMG4 is in an ON state. This causes the comparison voltage Vcomp to be supplied across the capacitor C1, via the transmission gate TMG2.

At this point, the voltage Vc has been held by the capacitor C1. This causes a voltage Vi (=Vcomp−(Vref−Vth)) to be supplied to the inverter INV1. In this state, when the comparison voltage Vcomp is greater than the reference voltage Vref (Vcomp−Vref=Vi−Vth>0), the inverter INV1 outputs a signal of a Low level. Accordingly, an output signal of the inverter INV2, that is, the comparator output signal OUTcomp, becomes in a High level. This causes the clock signal CK to be supplied to the charge pump circuit 112 via the NAND gate 111, so that the charge pump circuit 112 operates. Consequently, the output power supply voltage VSS decreases.

On the other hand, when the comparison voltage Vcomp is smaller than the reference voltage Vref (=Vcomp−Vref<0), the inverter INV1 outputs a signal of a High level. Accordingly, the comparator output signal OUTcomp has a Low level. As a result, the clock signal CK is no longer supplied to the charge pump circuit 112 via the NAND gate 111, so that the charge pump circuit 112 stops operating. Consequently, the output power supply voltage VSS increases by a voltage consumed by the source driver 8 and the gate driver 7.

In this way, during 1H period (horizontal scanning period), the comparison voltage Vcomp varies so as to be greater or smaller than the reference voltage Vref. The output power supply voltage VSS is outputted in response to the comparison voltage Vcomp. The repeated variation results in that the output power supply voltage VSS stably has a certain electric potential (−VDD, for example).

As described above, according to the power supply circuit 11, the reset signal RST rises and is in a High level (a reset pulse is outputted) in sync with rising and falling edges of the common signal VCOM. This causes the comparator 114 to be reset in sync with the rising and falling edges of the common signal VCOM, so that the comparator output signal OUTcomp is maintained in a ground level. Therefore, even if the voltage Vc held by the capacitor C1 is suddenly changed in response to the rising and falling edges of the common signal VCOM, a wrong comparator output signal OUTcomp cannot be outputted. This makes it possible to obtain a stable output power supply voltage VSS.

Further, the comparison voltage Vcomp repeatedly varies since the regulation is carried out throughout the 1H period. This causes the charge pump circuit 112 to repeatedly carry out on-off operation throughout the 1H period, so that the output power supply voltage VSS is constrained to vary within a small range. This allows an improvement in display quality of an image displayed by the liquid crystal display apparatus 1. Moreover, it is possible to reduce a power consumption of the power supply circuit 11 since it is not necessary to make the charge pump circuit 112 constantly operate.

[Arrangement of Second Power Supply Circuit]

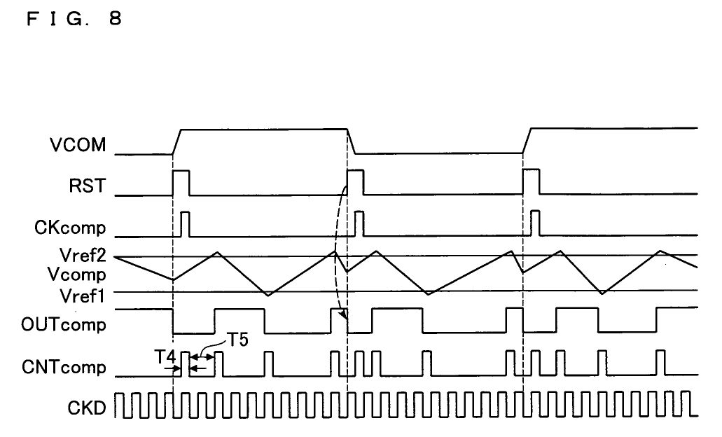

A power supply circuit 12 (second power supply circuit) is described below as another concrete example of the power supply circuit 9 with reference to FIGS. 4, 7, and 8. FIG. 7 is a circuit diagram showing an arrangement of the power supply circuit 12. FIG. 8 is a timing chart showing an operation of the power supply circuit 12.

In the power supply circuit 11, the variation of the comparison voltage Vcomp with respect to a single reference voltage Vref depends on an accuracy of the comparator 114. In cases where the comparator 114 has a high accuracy, it is possible to cause the output power supply voltage VSS to vary within a small range by causing the comparison voltage Vcomp to repeatedly vary. However, in cases where the comparator 114 has a low accuracy, the variation of the comparison voltage Vcomp with respect to the single reference voltage Vref becomes large, so that the charge pump circuit 112 repeatedly carries out on-off operation at wider intervals. As such, the output power supply voltage VSS varies within a wider range. This causes deterioration in display quality of an image displayed by the liquid crystal display apparatus 1.

The power supply circuit 12 described below is arranged so as to avoid such inconvenience.

As shown in FIG. 7, the power supply circuit 12 includes a NAND gate 111, a charge pump circuit 112, a voltage divider circuit 113, and a comparator 114, like the power supply circuit 11. The power supply circuit 12 further includes a reference voltage switching circuit 121, a switching control circuit 122, and an inverter 123.

The reference voltage switching circuit 121 switches, in accordance with a level of a comparator output signal OUTcomp, between two reference voltages Vref1 and Vref2 (Vref2>Vref1) so as to output either of them. For this purpose, the reference voltage switching circuit 121 includes transmission gates TMG11 and TMG12.

Vref1 is supplied to the transmission gate TMG11, whereas Vref2 is supplied to the transmission gate TMG12. Each of the transmission gates TMG11 and TMG12 is arranged so that a pair of p-channel transistor and n-channel transistor are connected in parallel with each other. The comparator output signal OUTcomp is supplied to a gate of the n-channel transistor of the transmission gate TMG11 and a gate of the p-channel transistor of the transmission gate TMG12. On the other hand, a comparator output signal OUTcomp inverted by the inverter 123 is supplied to a gate of the p-channel transistor of the transmission gate TMG11 and a gate of the n-channel transistor of the transmission gate TMG12.

While the comparator output signal OUTcomp is in a High state, the transmission gate TMG11 turns ON so that the reference voltage Vref1 is outputted, whereas the transmission gate TMG12 turns OFF so that the reference voltage Vref2 is not outputted. Conversely, while the comparator output signal OUTcomp is in a Low state, the transmission gate TMG11 turns OFF so that the reference voltage Vref1 is not outputted, whereas the transmission gate TMG12 turns ON so that the reference voltage Vref2 is outputted. In this way, the reference voltage Vref1 or Vref2 outputted from the reference voltage switching circuit 121 is supplied to the comparator 114 as a reference voltage Vref.

The switching control circuit 122 generates a control signal CNTcomp that substitutes for the clock signal CKcomp which is supplied to the comparator 114 in the power supply circuit 11. For this purpose, the switching control circuit 122 includes a D flip-flop (indicated by DFE in FIG. 7) 122a, inverters 122b and 122c, an ENOR (Exclusive-nor) gate 122d, an NAND gate 122e, an inverter 122f, and an OR gate 122g.

The D flip-flop 122a has a data input terminal D to which the comparator output signal OUTcomp is supplied, and a clock input terminal CLK to which a clock signal CKD is supplied. Further, the D flip-flop 122a outputs, via a data output terminal Q, data that has been held in sync with a rising edge of the clock signal CKD. The clock signal CKD is synchronized with a clock signal CKcomp, has a higher oscillation frequency than the clock signal Ckcomp, and has a duty ratio of 50%.

The ENOR 122d carries out an Exclusive NOR operation with regard to (i) the comparator output signal OUTcomp and (ii) the data of the D flip-flop 122a that has been inverted by the inverter 122b, and outputs a result of the Exclusive NOR operation. The NAND gate 122e carries out a NAND operation with regard to (i) the output signal of the ENOR 122d and (ii) a reset signal RST that has been inverted by the inverter 122c. The OR gate 122g outputs the control signal CNTcomp as a result of an OR operation with regard to (i) the clock signal CKcomp and (ii) the output signal of the NAND gate 122e that has been inverted by the inverter 122f. The output signal of the OR gate 122g is supplied to the comparator 114.

An operation of the power supply circuit 12 having the above-mentioned arrangement is described below with reference to the timing chart shown in FIG. 8.

As shown in FIG. 8, the reset signal RST rises in sync with a rising edge of a common signal VCOM. At this point, as in the power supply circuit 11, the charge pump circuit 112 stops operating because the comparator output signal OUTcomp is inverted so as to be changed from a High level into a Low level. Further, at this point, in the reference voltage switching circuit 121, the transmission gate TMG11 turns OFF, and the transmission gate TMG12 turns ON. This causes the reference voltage Vref2 to be supplied to the comparator 114 as the reference voltage Vref.

Meanwhile, the switching control circuit 122 outputs the control signal CNTcomp in response to the comparator output signal OUTcomp and the reset signal RST. The control signal CNTcomp includes a pulse rising in sync with the rising and falling edges of the comparator output signal OUTcomp. The control signal CNTcomp also includes a pulse-synchronized pulse that has the same phase and width as a clock pulse of the clock signal CKcomp generated in a reset period during which the reset signal RST is in a High level.

In the power supply circuit 12, the capacitor C1 of the comparator 114 (see FIG. 4) is charged by the reference voltage Vref (reference voltage Vref2) during a period (period T4) of the pulse-synchronized pulse in the control signal CNTcomp. This makes the period T4 be a preparation period for a comparison operation of the comparator 114. Further, a period T5 during which the comparison is carried out as in the period T2 is a period from when the control signal CNTcomp becomes a Low level until the next rising edge of the control signal CNTcomp.

As shown in FIG. 8, the comparison voltage Vcomp is lower than the reference voltage Vref (reference voltage Vref2) after the reset is carried out. This causes the comparator output signal OUTcomp to be maintained in a Low level. As a result, a clock signal CK is no longer supplied to the charge pump circuit 112 via the NAND gate 111, so that the charge pump circuit 112 stops operating. Consequently, the output power supply voltage VSS increases by a voltage to be consumed by the source driver 8 and the gate driver 7.

When the comparison voltage Vcomp reaches the reference voltage Vref (reference voltage Vref2), the comparator output signal OUTcomp is inverted so as to be in a High level. This causes the clock signal CK to be supplied to the charge pump circuit 112 via the NAND gate 111, so that the charge pump circuit 112 operates. Consequently, the output power supply voltage VSS decreases. Further, the control signal CNTcomp rises in sync with the comparator output signal OUTcomp being inverted so as to be in a High level. Therefore, like the period T4, a period during which the control signal CNTcomp is maintained in a High level is for preparation for the comparison operation.

When the comparator output signal OUTcomp is inverted so as to be in a High level, the transmission gate TMG11 turns ON, and the transmission gate TMG12 turns OFF in the reference voltage switching circuit 121. This causes the reference voltage Vref1 to be supplied to the comparator 114 as the reference voltage Vref.

When the comparison voltage Vcomp decreases so as to reach the reference voltage Vref (reference voltage Vref1), the comparator output signal OUTcomp is inverted so as to be in a Low level. As a result, the clock signal CK is no longer supplied to the charge pump circuit 112 via the NAND gate 111, so that the charge pump circuit 112 stops operating. Consequently, the output power supply voltage VSS increases again.

Repeating such an operation causes the comparison voltage Vcomp to vary between the reference voltage Vref1 and the reference voltage Vref2. In other words, the comparison voltage Vcomp stays within a range from the reference voltage Vref1 to the reference voltage Vref2. This makes it possible to control the output power supply voltage VSS without being affected by the accuracy of the comparator 114. Consequently, it becomes possible to obtain a stable output power supply voltage VSS.

[Arrangement of Third Power Supply Circuit]

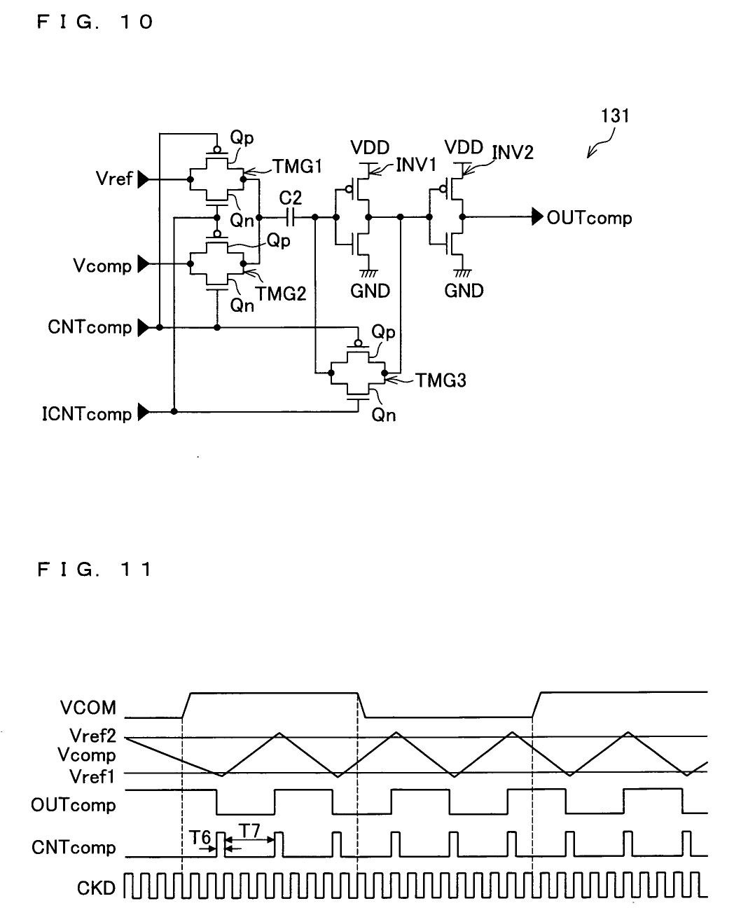

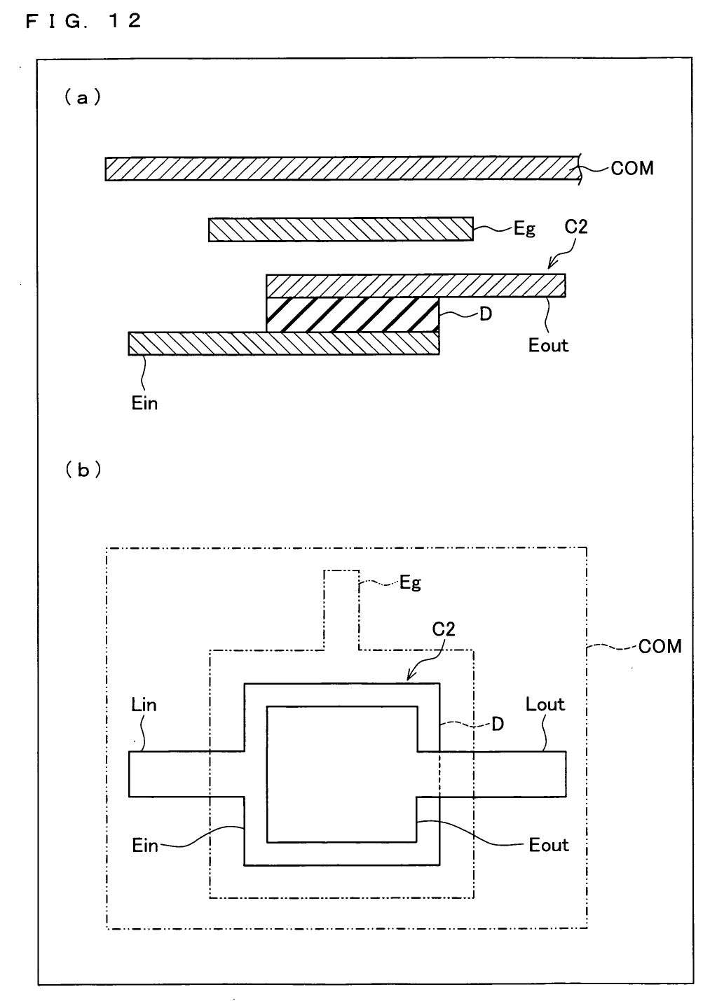

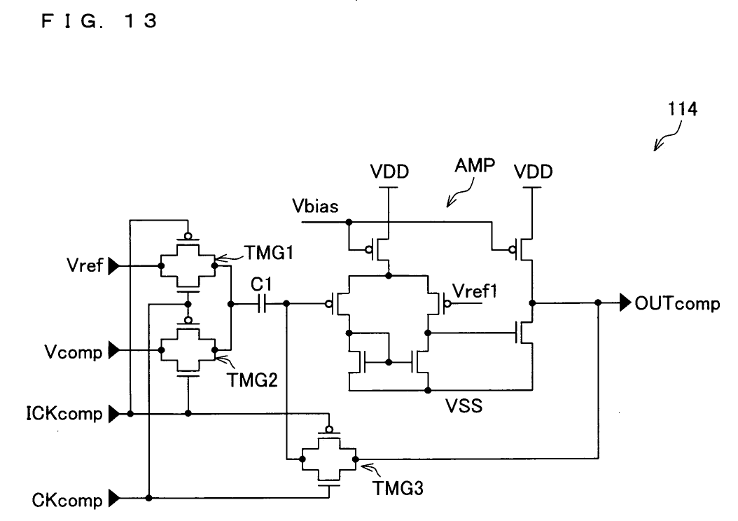

The following description deals with a power supply circuit 13 (third power supply circuit), which is a further concrete example of the power supply circuit 9, with reference to FIGS. 9 through 12. FIG. 9 is a circuit diagram showing an arrangement of the power supply circuit 13. FIG. 10 is a circuit diagram showing an arrangement of a comparator 131 in the power supply circuit 13. FIG. 11 is a timing chart showing an operation of the power supply circuit 13. (a) of FIG. 12 is a side view showing an arrangement of a capacitor C2 in the comparator 131. (b) of FIG. 12 is a cross-sectional view showing the arrangement of the capacitor C2.

As shown in FIG. 9, the power supply circuit 13 includes a NAND gate 111, a charge pump circuit 112, a voltage divider circuit 113, and a reference voltage switching circuit 121, like the power supply circuit 12. The power supply circuit 13 further includes a comparator 131 and a switching control circuit 132, instead of the comparator 114 and the switching control circuit 122, respectively.

As shown in FIG. 10, the comparator 131 includes transmission gates TMG1 through TMG3 and inverters INV1 and INV2, like the comparator 114. Note, however, that the comparator 131 does not include a transmission gate TMG4 and an n-channel transistor Qn1 (see FIG. 4). Further, the comparator 131 includes a capacitor C2 instead of the capacitor C1 in the comparator 114.

As shown in FIG. 9, the switching control circuit 132 includes a D flip-flop 122a, an inverter 122b, and an ENOR gate 122d, like the switching control circuit 122. Note, however, that the switching control circuit 132 does not include an inverter 122c, an NAND gate 122e, an inverter 122f, and an OR gate 122g (see FIG. 7). Further, the switching control circuit 132 supplies, as a control signal CNT comp, a output signal of the ENOR gate 122d to the comparator 131. In addition, an inverted control signal CNTcomp (not shown) is also supplied to the comparator 131.

As shown in (a) and (b) of FIG. 12, the capacitor C2 includes an input electrode Ein, an output electrode Eout, a dielectric layer D.

The input electrode Ein has a square shape, and is formed so as to be integral with an input line electrode Lin that extends to the left in (b) of FIG. 12. The output electrode Eout has a square shape which is slightly smaller than the input electrode Ein, and is formed so as to be integral with an output line electrode Lout that extends to the right in (b) of FIG. 12. A part of the input line electrode Lin, where the input electrode Ein is connected, corresponds to an input node. Likewise, a part of the output line electrode Lout, where the output electrode Eout is connected, corresponds to an output node.

Further, the input electrode Ein is provided on a substrate (substrate 4, not shown). The output electrode Eout is provided above the input electrode Ein so as to be parallel to the input electrode Ein. The dielectric layer D is sandwiched between the input electrode Ein and the output electrode Eout.

A ground electrode Eg constituting a ground line GND is provided above the output electrode Eout as an electrode layer, and provided on the substrate on which the input electrode Ein is provided. The ground electrode Eg has shape and size so as to cover the input electrode Ein, the output electrode Eout, the input node in the input line electrode Lin, and the output node in the output line electrode Lout. Further, a common electrode COM is provided on the other substrate (substrate 5, not shown) so as to face the ground electrode Eg.

Such an arrangement causes the capacitor C2 to be shielded with the ground electrode Eg. As such, a voltage held by the capacitor C2 is hardly affected by a variation in common signal VCOM that is applied to the common electrode COM. Therefore, the power supply circuit 13 does not require the reset signal RST that is used in the power supply circuits 11 and 12 (see FIGS. 3 and 7) for the purpose of avoiding being affected by the variation in the common signal VCOM.

An operation of the power supply circuit 13 arranged as above is described below with reference to the timing chart shown in FIG. 11.

As shown in FIG. 11, the switching control circuit 132 outputs a control signal CNTcomp including a pulse that rises in sync with rising and falling edges of a comparator output signal OUTcomp. In the comparator 131, a preparation (charging of the capacitor C2) for a comparison is carried out in a period (period T6) during which the pulse is maintained. The comparison is carried out during a period (period T7) between the pulse and its subsequent pulse. This causes the comparator output signal OUTcomp to be inverted every time a comparison voltage Vcomp reaches a reference voltage Vref1 or Vref2. Further, the charge pump circuit 112 operates and stops operating, repeatedly, in response to each inversion of the comparator output signal OUTcomp. An output power supply voltage VSS varies in response to the change in operation of the charge pump circuit 112.

In this way, without using the reset signal RST, the power supply circuit 13 is able to efficiently carry out a regulation operation by carrying out the comparison in the above-mentioned manner, unlike the power supply circuit 12 which carries out the comparison every time the common signal VCOM is inverted. Therefore, it is possible to make the output power supply voltage VSS vary within a smaller range than the output power supply voltage VSS in the power supply circuit 12.

Note that, in the power supply circuit 13, the comparator 131 may erroneously operate as a result of being affected by the common signal VCOM, although the capacitor C2 is shielded with the ground electrode Eg. However, even if a voltage Vc held by the capacitor C2 is changed by a sudden change in the common signal VCOM due to each inversion, this only causes a slight increase in amplitude of the output power supply voltage VSS. This is because the power supply circuit 13 uses the two reference voltages Vref1 and Vref2 as the reference voltage Vref.

The embodiments deal with an arrangement in which a negative output power supply voltage VSS is obtained by the charge pump circuit 112. However, the charge pump circuit 112 can be arranged so as to supply a positive or negative voltage that is n times (n is an integer number that is not less than 1) of an input power supply voltage VDD.

Further, the embodiments deal with an arrangement in which each of the comparators 114 and 131 is a chopper type comparator. However, the comparators 114 and 131 are not limited to the chopper type comparator, and can be a differential comparator shown in FIG. 13, for example. The differential comparator includes transmission gates TMG1 through TMG3 and a capacitor C1, like the chopper type comparator. The differential comparator includes a differential amplifier AMP instead of the inverters INV1 and INV2. In the differential comparator, a transmission gate TMG3 is provided between an input terminal and an output terminal of the differential amplifier AMP.

Note that, in the differential comparator shown in FIG. 13, the transmission gate TMG4 and the n-channel transistor Qn1 that are used in the comparator 114 shown in FIG. 4 are omitted for convenience sake.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

A power supply circuit of the present invention is arranged so as to become less likely to be affected by a variation in common signal that is applied to a common electrode in a liquid crystal display apparatus, and therefore it is applicable to a use in which a display quality of the liquid crystal display apparatus is intended to be improved.

1. A power supply circuit comprising:
a charge pump circuit for carrying out a charge pump operation so as to supply a power supply voltage to a driving circuit of a liquid crystal display apparatus in which an electric potential of a common electrode shared by a plurality of pixels is inverted so as to have two values in a predetermined cycle;
a voltage divider circuit for dividing a difference voltage between an input power supply voltage and a voltage outputted from the charge pump circuit;
a regulation circuit including a comparator with a capacitor to be charged by a reference voltage so that the reference voltage is compared with a voltage outputted from the voltage divider circuit, the regulation circuit stabilizing a power output by controlling the charge pump circuit based on a compared result; and
a control section for resetting the comparator in the predetermined cycle, and for controlling the comparator to carry out a comparison after the electric potential of the common electrode is inverted.

2. A power supply circuit comprising:
a charge pump circuit for carrying out a charge pump operation so as to supply a power supply voltage to a driving circuit of a liquid crystal display apparatus in which an electric potential of a common electrode shared by a plurality of pixels is inverted so as to have two values in a predetermined cycle;
a voltage divider circuit for dividing a difference voltage between an input power supply voltage and a voltage outputted from the charge pump circuit; and
a regulation circuit including a comparator with a capacitor to be charged by a reference voltage so that the reference voltage is compared with a voltage outputted from the voltage divider circuit, the regulation circuit stabilizing a power output by controlling the charge pump circuit based on a compared result,
the capacitor being shielded with an electrode layer provided between the capacitor and the common electrode.

3. The power supply circuit according to claim 1, wherein:
the reference voltage includes different first and second reference voltages; and
said power supply circuit, further comprising:
a switching circuit for switching between the first and second reference voltages in response to an output of the comparator.

4. A liquid crystal display apparatus, comprising:
a driving circuit for driving a plurality of pixels, and
a power supply circuit, provided, together with the driving circuit, on a translucent substrate on which the plurality of pixels are provided, for outputting a power supply voltage to the driving circuit:
said power supply circuit, including:
a charge pump circuit for carrying out a charge pump operation so as to supply a power supply voltage to a driving circuit of a liquid crystal display apparatus in which an electric potential of a common electrode shared by a plurality of pixels is inverted so as to have two values in a predetermined cycle;
a voltage divider circuit for dividing a difference voltage between an input power supply voltage and a voltage outputted from the charge pump circuit;
a regulation circuit including a comparator with a capacitor to be charged by a reference voltage so that the reference voltage is compared with a voltage outputted from the voltage divider circuit, the regulation circuit stabilizing a power output by controlling the charge pump circuit based on a compared result; and
a control section for resetting the comparator in the predetermined cycle, and for controlling the comparator to carry out a comparison after the electric potential of the common electrode is inverted.

5. A liquid crystal display apparatus, comprising:
a driving circuit for driving a plurality of pixels, and
a power supply circuit, provided, together with the driving circuit, on a translucent substrate on which the plurality of pixels are provided, for outputting a power supply voltage to the driving circuit:
said power supply circuit, including:
a charge pump circuit for carrying out a charge pump operation so as to supply a power supply voltage to a driving circuit of a liquid crystal display apparatus in which an electric potential of a common electrode shared by a plurality of pixels is inverted so as to have two values in a predetermined cycle;
a voltage divider circuit for dividing a difference voltage between an input power supply voltage and a voltage outputted from the charge pump circuit; and
a regulation circuit including a comparator with a capacitor to be charged by a reference voltage so that the reference voltage is compared with a voltage outputted from the voltage divider circuit, the regulation circuit stabilizing a power output by controlling the charge pump circuit based on a compared result,
the capacitor being shielded with an electrode layer provided between the capacitor and the common electrode.

6. The liquid crystal display apparatus according to claim 4, wherein:
the reference voltage includes different first and second reference voltages; and
said power supply circuit, further comprising:
a switching circuit for switching between the first and second reference voltages in response to an output of the comparator.

7. The power supply circuit according to claim 2, wherein:
the reference voltage includes different first and second reference voltages; and
said power supply circuit, further comprising:
a switching circuit for switching between the first and second reference voltages in response to an output of the comparator.

8. The liquid crystal display apparatus according to claim 5, wherein:
the reference voltage includes different first and second reference voltages; and
said power supply circuit, further comprising:
a switching circuit for switching between the first and second reference voltages in response to an output of the comparator.
